(19) United States
(12) Patent Application Publication
(10) Pub. No.: US 2026/0340015 A1
(43) Pub. Date: Oct. 29, 2026

(54) AI Augmented Display of Complex Measurements

(71) Applicant: NATIONAL INSTRUMENTS CORPORATION, Austin, TX (US)

(72) Inventors: Christopher G. Cifra, Austin, TX (US); Stephen L. Dark, Austin, TX (US); Kiran Sreekantham, Austin, TX (US)

(21) Appl. No.: 19/658,105

(22) Filed: Apr. 24, 2026

Related U.S. Application Data
(60) Provisional application No. 63/795,282, filed on Apr. 26, 2025.

(51) Int. Cl. G06F 16/338; G06F 16/334

(52) U.S. Cl. CPC G06F 16/338; G06F 16/334

(57) ABSTRACT

Apparatuses, systems, and methods for Artificial Intelligence (AI) assisted display of complex measurement data, e.g., using an extensible visualization library to enable an AI based system to consume and display data associated with complex measurements. An AI can receive instructions for visualization of data. The AI can, to produce the visualization of the data, compare the instructions to functions in the extensible visualization library and determine whether a function is a match to the instructions. Based on results of the comparison, the AI can generate the visualization of the data using code associated a function in the extensible visualization library or using code generated by the AI based on the instructions, based on a function that is a close match to the instructions, or based on one or more functions that are a relative match.

### PRIORITY CLAIM

This application claims benefit of priority to provisional Application No. 63/795,282 entitled “AI Augmented Display of Complex Measurements”, filed on Apr. 26, 2025, whose disclosure is hereby incorporated by reference in its entirety as though fully and completely set forth herein.

### TECHNICAL FIELD

The invention relates to display of complex measurement data, and more particularly to apparatuses, systems, and methods for Artificial Intelligence (AI) assisted display of complex measurement data, e.g., using an extensible visualization library to enable an AI based system to consume and display data associated with complex measurements.

### DESCRIPTION OF THE RELATED ART

Currently, there is a critical need to graph complex data. This arises from the need to interpret and analyze vast amounts of data accurately and efficiently. Complex data visualization can be essential for making informed decisions, identifying trends, and uncovering insights that might not be immediately apparent from raw data alone. The ability to graph such data in a clear and precise manner is indispensable for professionals across various fields, including engineering, science, finance, healthcare, and so forth.

Traditionally, there have been two primary approaches to visualizing complex measurement data that do not involve artificial intelligence: (1) writing custom code and (2) using predefined graphing packages. Both of these approaches offer benefits while also having drawbacks. For example, custom code offers a high degree of customization, allowing users to create visualizations that precisely meet their unique requirements, however, it is inherently time-consuming and demands a significant level of expertise in coding. Moreover, maintaining and updating custom code can be challenging, especially as data visualization needs evolve over time. As another example, utilizing predefined graphing packages can produce high-quality visualizations with minimal effort from a user. Such graphing packages can be used to quickly generate standard graphs and charts without the need for extensive coding, however, these graphing packages can lack customizability and constrain users to the predefined templates and styles available in the package which may not always align with their specific needs or preferences.

Recently, artificial intelligence, particularly Large Language Models (LLMs), has emerged as a powerful tool for creating graphs and visualizations. For example, LLMs are now being employed for graphical content creation. In particular, in the field of test and measurement, there is a growing trend to leverage LLMs to automate the process of visualizing complex data. This approach involves using LLMs to write code for generating visualizations, ensuring that the data is graphed based on actual values rather than the potential fuzziness that can come from human error or subjective interpretation. However, while use of LLMs for creating graphs offers several advantages, it can also present certain challenges as the code generated by LLMs often lacks consistency in style and quality which can result in visualizations that are not as polished or professional as those created through traditional methods. Additionally, LLM-generated code can struggle to handle the complexity and volume of data typically encountered in test and measurement scenarios. Therefore, improvements are desirable.

### SUMMARY

Embodiments described herein relate to computing systems, memory media, and methods for Artificial Intelligence (AI) assisted display of complex measurement data, e.g., using an extensible visualization library to enable an AI based system to consume and display data associated with complex measurements.

For example, in some embodiments, an automated agent (e.g., an artificial intelligence (AI) model such as a large language model (LLM)) can receive instructions for visualization of data, e.g., an LLM can receive user generated instructions for visualization of data via a user experience interface (UX). The LLM can access the data and visualization resources that includes functions for visualizing the data (e.g., an extensible visualization library). The LLM can produce a visualization of the data based, at least in part, on the instructions and the functions for visualizing data. The LLM can, to produce the visualization of the data, compare the instructions to functions in the extensible visualization library and determine whether a function in the extensible visualization library is an exact match to the instructions. Based on results of the comparison, the LLM can then generate the visualization of the data using code associated with a function (e.g., an exact match) in the extensible visualization library or using code generated by the LLM based on the instructions, based on a function that is a close match to the instructions, or based on one or more functions that are a relative match. Upon finalization of the visualization of the data, the LLM can add code generated for the visualization of the data to the extensible visualization library as a new function.

Note that the techniques described herein can be implemented in and/or used with a number of different types of devices, including but not limited to cellular phones, tablet computers, wearable computing devices, portable computing devices, portable media players, and any of various other computing devices.

This Summary is intended to provide a brief overview of some of the subject matter described in this document. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the disclosed embodiments can be obtained when the following detailed description of the preferred embodiments is considered in conjunction with the following drawings.

FIG. 1 illustrates an example of a computer system, according to some embodiments.

FIG. 2 illustrates an example block diagram of a server 104, according to some embodiments.

FIG. 3 illustrates an example of a system supporting an AI assisted display of complex measurement data, according to some embodiments.

FIG. 4 illustrates a block diagram of example of flowchart for AI assisted visualization of data, according to some embodiments.

FIG. 5 illustrates a block diagram of an example of a method for artificial intelligence (AI) assisted visualization of data, according to some embodiments.

While the features described herein can be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium – Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium can include other types of non-transitory memory as well or combinations thereof. In addition, the memory medium can be located in a first computer system in which the programs are executed, or can be located in a second different computer system which connects to the first computer system over a network, such as the Internet. In the latter instance, the second computer system can provide program instructions to the first computer for execution. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium – a memory medium as described above, as well as a physical transmission medium, such as a bus, network, and/or other physical transmission medium that conveys signals such as electrical, electromagnetic, or digital signals.

Programmable Hardware Element – includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks can range from fine grained (combinatorial logic or look up tables) to coarse grained (arithmetic logic units or processor cores). A programmable hardware element can also be referred to as “reconfigurable logic”.

Computer System (or Computer) – any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Processing Element (or Processor) – refers to various elements or combinations of elements that are capable of performing a function in a device, such as a user equipment or a cellular network device. Processing elements can include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Program – the term “program” is intended to have the full breadth of its ordinary meaning. The term “program” includes 1) a software program which can be stored in a memory and is executable by a processor or 2) a hardware configuration program useable for configuring a programmable hardware element.

Software Program – the term “software program” is intended to have the full breadth of its ordinary meaning, and includes any type of program instructions, code, script and/or data, or combinations thereof, that can be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program can comprise two or more software programs that interoperate in some manner.

User Experience (UX) Interface – the term “user experience interface” is intended to have the full breadth of its ordinary meaning and refers to one or more interfaces through which a user interacts with a system to provide input and/or receive output. A user experience interface can include, but is not limited to, graphical user interfaces (GUIs), command-line interfaces, natural language interfaces, application programming interfaces (APIs), or any combination thereof. A user experience interface can include input elements, output elements, or both. Input elements can include any mechanisms for receiving user input, such as text entry, voice input, gesture input, or other forms of input. Output elements can include any mechanisms for presenting information to a user, such as visual displays, textual outputs, audio outputs, or other forms of output. A user experience interface can be implemented in hardware, software, or a combination thereof, and can be provided locally, remotely, or in a distributed manner across one or more devices or systems.

Extensible Library – the term “extensible library” is intended to have the full breadth of its ordinary meaning and refers to a collection of functions, routines, templates, modules, code segments, or other programmatic constructs that are accessible for use by one or more systems or components. An extensible library is capable of being modified over time, including through addition, removal, or modification of elements within the library. Elements within an extensible library can be associated with metadata, descriptors, or other information usable for identification, selection, organization, or comparison. An extensible library can be stored in one or more memory locations and can be accessible locally, remotely, or in a distributed manner across one or more systems.

Automated Agent – the term “automated agent” is intended to have the full breadth of its ordinary meaning and refers to a software-based or hardware-implemented entity configured to perform one or more tasks autonomously or semi-autonomously based on input data, rules, learned models, or combinations thereof. An automated agent can include, for example, one or more artificial intelligence models, machine learning models, large language models (LLMs), rule-based systems, or combinations thereof.

Match / Matching – the terms “match” or “matching” are intended to have the full breadth of their ordinary meaning and refer to a determination of a degree of correspondence between two or more items. Matching can be performed based on any of various criteria, including but not limited to syntactic similarity, semantic similarity, structural similarity, parameter correspondence, contextual similarity, or any combination thereof. Matching can be based on exact correspondence, partial correspondence, or relative correspondence. Matching can be implemented using rule-based techniques, heuristic techniques, statistical methods, machine learning models, or combinations thereof. Matching can include determining one or more candidate correspondences and optionally ranking, scoring, filtering, or otherwise evaluating the candidate correspondences according to one or more criteria. A match can be determined based on one or more thresholds, scoring mechanisms, comparison techniques, or decision processes.

Automatically – refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure can be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form can be automatically filled out by the computer system where the computer system (e.g., software executing on the computer system) analyzes the fields of the form and fills in the form without any user input specifying the answers to the fields. As indicated above, the user can invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately – refers to a value that is almost correct or exact. For example, approximately can refer to a value that is within 1 to 10 percent of the exact (or desired) value. It should be noted, however, that the actual threshold value (or tolerance) can be application dependent. For example, in some embodiments, “approximately” can mean within 0.1% of some specified or desired value, while in various other embodiments, the threshold can be, for example, 2%, 3%, 5%, and so forth, as desired or as required by the particular application.

Concurrent – refers to parallel execution or performance, where tasks, processes, or programs are performed in an at least partially overlapping manner. For example, concurrency can be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

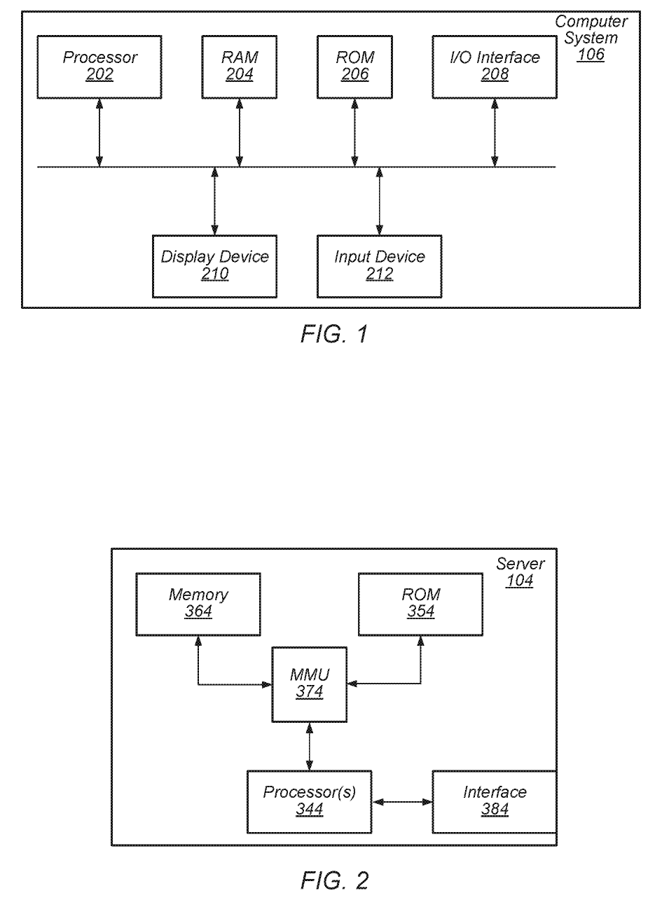

### FIG. 1: Computer System

FIG. 1 illustrates a computer system 106 that can include a processor 202, random access memory (RAM) 204, nonvolatile memory 206, a display device 210, an input device 212 and an I/O interface 208 for coupling to sensors. For example, the computer system 106 can include hardware and software components for implementing or supporting implementation of features described herein. The processor 202 can be configured to implement or support implementation of part or all of the methods described herein, e.g., by executing program instructions stored on a memory medium (e.g., a non-transitory computer-readable memory medium). Alternatively, the processor 202 can be configured as a programmable hardware element, such as an FPGA (Field Programmable Gate Array), or as an ASIC (Application Specific Integrated Circuit), or a combination thereof. Alternatively (or in addition) the processor 202, in conjunction with one or more of the other components 204, 206, 208, 210, and/or 212 can be configured to implement or support implementation of part or all of the features described herein.

In addition, as described herein, processor(s) 202 can be comprised of one or more processing elements. In other words, one or more processing elements can be included in processor(s) 202. Thus, processor(s) 202 can include one or more integrated circuits (ICs) that are configured to perform the functions of processor(s) 202. In addition, each integrated circuit can include circuitry (e.g., first circuitry, second circuitry, etc.) configured to perform the functions of processor(s) 202.

As shown, the computer system 106 can include a processor that is coupled to a random access memory (RAM) and a nonvolatile memory. The computer system 106 can also include user experience interface (UX) elements for receiving user input and a display device for presenting output. For example, the UX elements can include any of various elements, such as a display (which can be a touchscreen display), a keyboard (which can be a discrete keyboard or can be implemented as part of a touchscreen display), a mouse, a microphone and/or speakers, one or more cameras, one or more buttons, and/or any of various other elements capable of providing information to a user and/or receiving or interpreting user input. The computer system 106 can also include an Input/Output (I/O) interface that can be communicatively coupled (e.g., locally via a system bus, or remotely via a network and/or serial interface) to various hardware elements (e.g., such as FPGAs, data acquisition boards, controllers, and the like).

### FIG. 2: Server

FIG. 2 illustrates an example block diagram of a server 104, according to some embodiments. It is noted that the server of FIG. 2 is merely one example of a possible server. As shown, the server 104 can include processor(s) 344 which can execute program instructions for the server 104. The processor(s) 344 can also be coupled to memory management unit (MMU) 374, which can be configured to receive addresses from the processor(s) 344 and translate those addresses to locations in memory (e.g., memory 364 and read only memory (ROM) 354) or to other circuits or devices.

The server 104 can be configured to provide a plurality of devices, such as computer system 106, access to a generative AI, e.g., as further described herein.

In some embodiments, the server 104 can be accessed via a radio access network, such as a 5G New Radio (5G NR) radio access network, e.g., via supported and/or via interface 384. In some embodiments, the server 104 can be accessed via a local area network (LAN), e.g., via an ethernet and/or Wi-Fi connection (e.g., supported and/or via interface 384).

As described further subsequently herein, the server 104 can include hardware and software components for implementing or supporting implementation of features described herein. The processor 344 of the server 104 can be configured to implement or support implementation of part or all of the methods described herein, e.g., by executing program instructions stored on a memory medium (e.g., a non-transitory computer-readable memory medium). Alternatively, the processor 344 can be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 can be configured to implement or support implementation of part or all of the features described herein.

In addition, as described herein, processor(s) 344 can be comprised of one or more processing elements. In other words, one or more processing elements can be included in processor(s) 344. Thus, processor(s) 344 can include one or more integrated circuits (ICs) that are configured to perform the functions of processor(s) 344. In addition, each integrated circuit can include circuitry (e.g., first circuitry, second circuitry, etc.) configured to perform the functions of processor(s) 344.

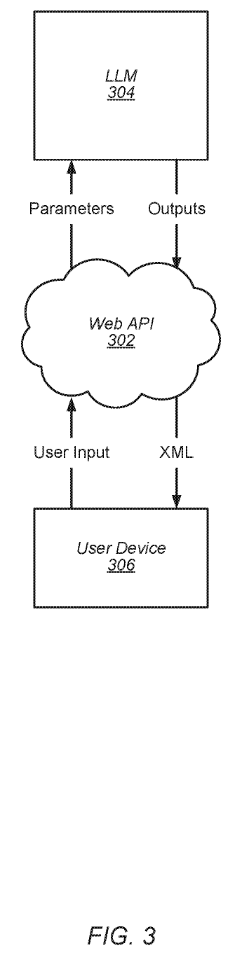

### FIG. 3: AI Assisted Display of Complex Measurement System

FIG. 3 illustrates an example of a system supporting an AI assisted display of complex measurement data, according to some embodiments. As shown, the system can include a user device 306, e.g., which can be a computer system 106 that provides an interface with an LLM 304 (e.g., which can be hosted on a server, such as server 104) via a web Application Programming Interface (API) 302. In at least some instances, the LLM 304 can be one or more models 304 (e.g., one or more artificial intelligence models). In some instances, the LLM 304 can be considered an example of an automated agent as described herein. The interface can allow the LLM 304 to interact with (e.g., communicate with) local hardware either on the user device 306 and/or in communication with the user device 306. In addition, the interface can allow the LLM 304 to interact with local software resources (e.g., such as programming platforms (e.g., LabVIEW^{TM}, Python, C++, MATLAB^{TM}, and so forth). Thus, as shown, a user can interact with the LLM 304 via web API 302 using the user device 306. The user device 306 can execute one or more software resources as well as host hardware (e.g., such as data acquisition boards, control boards, vision boards, and the like) and/or communicate with remote hardware (e.g., such as data acquisition boards, control boards, vision boards, and the like). The user device 306 can provide user inputs, including instructions for visualization of data. The web API 302 can convert the user inputs to LLM parameters and/or the web API 302 can generate LLM parameters based on the user inputs. The LLM parameters can be used by the LLM 304 to generate and/or produce model outputs that are returned to the web API 302. The web API 302 can then convert the model outputs to Extensible Markup Language (XML) and/or JavaScript Object Notation (JSON) and/or generate XML and/or JSON based on the model outputs. For example, the model outputs can include code for displaying complex measurement data, e.g., according to user inputs. Note further, that aspects of the LLM 304 can include a UX executing on the user device 306 as well as background software to discover and maintain hardware information as well as to discover and maintain connections with local applications, the web API 302 to allow the user device 306 to interact with the LLM 304, and the LLM 304 that can be executing on a server remote from the user (e.g., the LLM 304 can be cloud based).

### AI Assisted Display of Complex Measurement Data

Currently, there is a critical need to graph complex data. This arises from the need to interpret and analyze vast amounts of data accurately and efficiently. Complex data visualization can be essential for making informed decisions, identifying trends, and uncovering insights that might not be immediately apparent from raw data alone. The ability to graph such data in a clear and precise manner is indispensable for professionals across various fields, including engineering, science, finance, healthcare, and so forth.

Traditionally, there have been two primary approaches to visualizing complex measurement data that do not involve artificial intelligence: (1) writing custom code and (2) using predefined graphing packages. Both of these approaches offers benefits while also having drawbacks.

For example, custom code can offer a high degree of customization, allowing users to create visualizations that precisely meet their unique requirements. However, generating custom code is inherently time-consuming and can demand a significant level of expertise in coding. Users must possess advanced knowledge of programming languages and graphing libraries to achieve the exact visual effects they desire. Further, the process of generating graphics can be tedious, involving meticulous attention to detail and iterative refinement to ensure accuracy and clarity. This can be a major drawback for users who may not have the necessary coding skills or the time to invest in creating custom visualizations. Moreover, maintaining and updating custom code can be challenging, especially as data visualization needs evolve over time.

As another example, utilizing predefined graphing packages that come with a set of built-in templates and styles can allow a user to produce high-quality visualizations with minimal effort. These predefined graphing packages can offer a convenient solution for quickly generating standard graphs and charts without the need for extensive coding. However, the primary limitation of these predefined graphing packages is the lack of customizability. Users are constrained by the predefined templates and styles available in the package which may not always align with their specific needs or preferences. This can be particularly problematic when dealing with unique or highly specialized data sets that require tailored visual representations. Thus, while predefined graphing packages can deliver good end results, they often fall short in providing the flexibility needed to adapt to diverse and complex data visualization requirements.

In recent years, artificial intelligence, particularly Large Language Models (LLMs), has emerged as a powerful tool for creating graphs and visualizations. LLMs are increasingly being utilized for more than just content creation; LLMs are now being employed for graphical content creation as well. In the field of test and measurement, there is a growing trend to leverage LLMs to automate the process of visualizing complex data. The approach involves using LLMs to write the code for generating visualizations, ensuring that the data is graphed based on actual values rather than the potential fuzziness that can come from human error or subjective interpretation. However, while the use of LLMs for creating graphs offers several advantages, it also presents certain challenges. One of the key benefits of leveraging LLMs is the ability to quickly generate visualizations without the need for extensive coding knowledge; LLMs can automate this process, saving time and effort for users. However, the code generated by LLMs often lacks consistency in style and quality and this lack of consistency can result in visualizations that are not as polished or professional as those created through traditional methods. Additionally, LLM generated code can struggle to handle the complexity and volume of data typically encountered in test and measurement scenarios. Simplifying the visuals while maintaining a high volume of data is often beyond the capabilities of a large language model to code consistently. Therefore, improvements are desirable.

Embodiments described herein provide systems, methods, and mechanisms for Artificial Intelligence (AI) assisted display of complex measurement data, e.g., using an extensible visualization library to enable an AI based system to consume and display data associated with complex measurements. For example, an extensible visualization library can leverage predefined code and an LLM to combine strengths of both traditional methods (e.g., custom code generation and predefined graphing packages) and the LLM to offer a flexible and efficient solution for visualizing complex measurement data. As used herein, the term “extensible visualization library” refers to an extensible library that includes functions or constructs associated with generation, modification, or presentation of visualizations. For example, the extensible visualization library can include a set of predefined functions and templates that can be accessed and utilized by the LLM (and/or LLMs). The functions and templates can be designed to handle a wide range of data visualization scenarios, ensuring that critical information is prominently displayed while secondary information is appropriately backgrounded. In addition, the extensible visualization library can be designed to provide a flexible and efficient solution for generating high-quality visualizations of complex measurement data. As an example, the extensible visualization library can be utilized for direct function calls, to support the LLM in modification of existing functions (e.g., code), to provide the LLM with references and/or examples to generate new code (e.g., new visualizations), and to store custom visualizations generated via the LLM. Further, embodiments described herein can offer several key advantages over traditional methods of data visualization, e.g., such as efficiency, consistency, flexibility, and scalability while being user friendly and allowing personalization. For example, by leveraging a set of predefined functions and/or templates, an LLM can generate high-quality visualizations more quickly and efficiently than by writing custom code from scratch, leading to improved efficiency and reducing time and effort required to create complex visualizations and allowing users to focus on analyzing and interpreting the data. As another example, usage of a standardized library (e.g., the set of predefined functions) can ensure that all visualizations adhere to a consistent style and quality, making it easier for users to interpret and compare different sets of data. Such consistency can be particularly important in professional settings where clear and accurate data representation is crucial. As a further example, the library's extensible nature allows it to be flexible and accommodate a wide range of data visualization needs, from simple graphs to complex multi-dimensional representations and users can easily customize the visualizations to meet their specific requirements, ensuring that the final output is tailored to their needs. As yet another example, the extensible visualization library (e.g., library) can be easily expanded with new functions and templates (e.g., scaled), ensuring that it remains relevant and useful as new data visualization challenges arise. Such scalability allows the library to grow and evolve alongside the user's needs, providing a long-term solution for data visualization. Additionally, by simplifying the process of generating complex visualizations, the library makes it easier for users to understand and interpret large volumes of measurement data. This user-friendly approach enhances the overall experience, making data visualization more accessible to a wider audience. Finally, allowing the library to expand to store and recall custom visualizations can ensure that users receive tailored graphs that align with their preferences. This personalization saves time and effort, providing users with consistent and high-quality visualizations without the need for repeated customization. Note that in the instances described herein, the LLM can be an example of an automated agent. The automated agent can be for example, the LLM, or can include other types of machine-learned or rule-based systems configured to perform similar operations.

In some instances, an extensible visualization library (e.g., library) can include a robust (e.g., near complete, extensive, exhaustive) set of predefined functions. The set of predefined functions can be designed to handle common data visualization tasks, such as plotting graphs, creating charts, and generating complex visual representations of measurement data. Thus, the library, and more particularly, the set of predefined functions, can be considered an extensive repository of example visualizations that can be used as references by an LLM. These examples can cover a wide range of data visualization scenarios, providing valuable insights into best practices for representing complex measurement data. An LLM (e.g., such as LLM 304) can query or call functions from the set of predefined functions, e.g., the functions from the set of predefined functions can be directly called by the LLM. In some instances, by leveraging the set of predefined functions, the LLM can quickly and accurately generate high-quality visualizations without the need for extensive custom coding. Such an approach can save time and ensure consistency in the style and quality of the visualizations. For example, if and/or when a user needs or wants to visualize a set of measurement data as a line graph, the LLM can call a predefined function within the library that is specifically designed for to visualize the set of measurement data as a line graph. The LMM can provide the set of measurement data to the predefined function as input data, and via the predefined function, apply necessary formatting and generate a line graph to accurately represent the set of measurement data. Such a process can be efficient and reliable, providing users with high-quality visualizations in a fraction of the time it would take to write custom code.

In some instances, e.g., such as when the set of predefined functions in the extensible visualization library (e.g., library) are not sufficient to meet a user's specific requirements for visualization, an LLM (such as LLM 304) can utilize the library's existing code as a starting point. For example, the LLM can analyze the library to determine closest matches within the library that meet the user’s specific requirements and then modify these closest matches to create and/or generate code for the visualization. In some instances, the LLM can adapt existing code to fit specific data and visualization requirements, ensuring that a final output (e.g., visualization) is both accurate and visually appealing. Thus, by starting with a strong foundational base (e.g., the robust set of predefined functions), the LLM can produce more stable and higher-quality visualizations compared to generating code from scratch. For example, if and/or when a user needs a customized bar chart that includes additional annotations or specific color schemes, an LLM can search the library for a similar bar chart function and then modify code used to generate the bar chart to meet the user’s specific needs. In other words, the LLM, upon prompting from the use, can adjust the code to include the desired annotations and apply the specified color schemes, resulting in a customized bar chart that meets the user's specifications.

In some instances, e.g., such as when the set of predefined functions in the extensible visualization library (e.g., library) are not sufficient to meet a user's specific requirements for visualization, an LLM (such as LLM 304) can utilize the library's existing code as a starting point. For example, the LLM can analyze the library to determine closest matches within the library that meet the user’s specific requirements and then modify these closest matches to create and/or generate code for the visualization. In some instances, such as when the LLM cannot determine a closest match for the user’s specific requirements, the LLM can use the set of predefined functions as for creation of new visualizations, e.g., to meet the user’s specific requirements. Such an approach can ensure that the new visualizations adhere to established style and quality standards, resulting in a cohesive and professional presentation of data. For example, if and/or when a user needs to create a multi-dimensional scatter plot that is not directly available in the library, an LLM can refer to similar functions of the set of predefined functions, analyze the similar functions, and determine and/or understand best practices for creating multi-dimensional scatter plot. The LLM can then apply this knowledge to generate a new visualization that meets the user's needs.

In some instances, e.g., such as when a user interacts with an LLM, such as LLM 304, to create custom (e.g., new) visualizations, the custom visualization can be added to the extensible visualization library, e.g., as part of a set of LLM and/or user defined functions. Such a scheme can enable the LLM to have “memory” (e.g., additional functions/examples) for desired graphs and customizations, tailoring future visualizations to be similar. Further, storing and/or adding custom visualizations to the LLM/user defined functions can allow the LLM to recall and reuse these tailored graphs, saving time for the user since they do not have to customize everything from scratch each time. This scheme also further enhances the efficiency and personalization of the visualization process, ensuring that a user receives consistent and high-quality visualizations that align with their preferences. For example, if and/or when a user frequently requires a specific type of graph with unique formatting and annotations, the LLM can store this custom graph in the set of LLM/user defined functions. Then, in future requests, the LLM can retrieve and adapt this stored function, providing the user with a consistent and familiar visualization that meets their needs without requiring extensive customization.

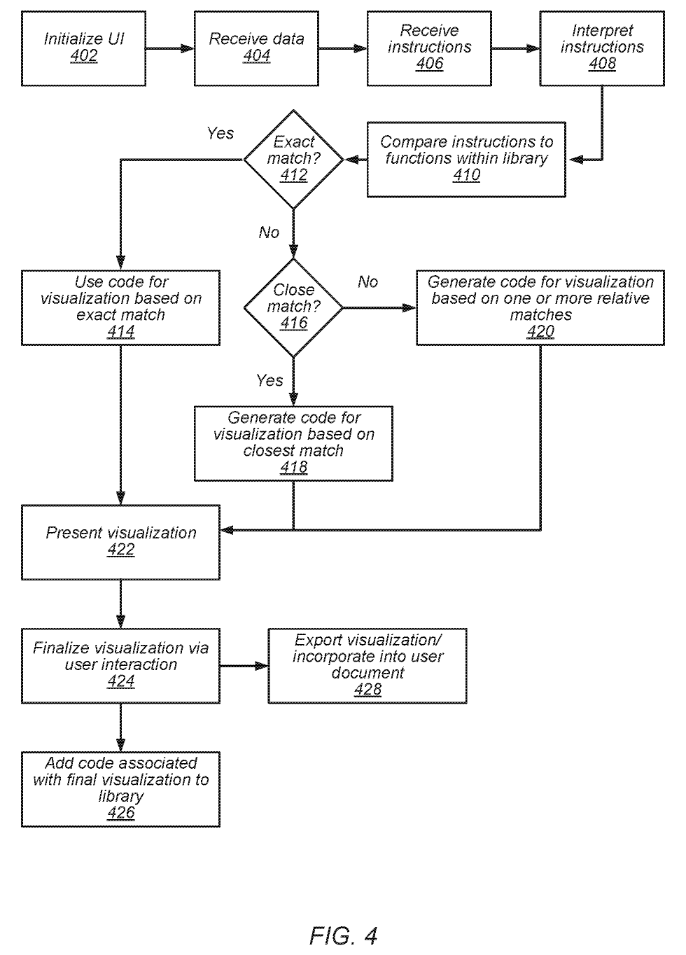

For example, FIG. 4 illustrates a block diagram of example of flowchart for AI assisted visualization of data, according to some embodiments. The flowchart shown in FIG. 4 can be used in conjunction with any of the systems, methods, or devices shown in the Figures, among other devices. In various embodiments, some of the elements shown can be performed concurrently, in a different order than shown, or can be omitted. Additional elements can also be performed as desired. Turning to FIG. 4, as shown, this flowchart can operate as follows.

At 402, a user can initialize a UX for interacting with a large language model (LLM), such as LLM 304. The UX can be executing on a user device, such as 306 and the LLM can be interacted with via a web API, such as 302. In such instances, the LLM can be located on a server, such as server 104. In other instances, the UX can be executing on the user device and the LLM can be installed locally on the user device. In some instances, the UX can be a chat style UX.

At 404, the LLM can receive data that the user would like to visualize. For example, the user can provide the LLM with the data via the UX and/or the user can instruct, via the UE, the LLM to access the data, e.g., by providing instructions indicating a location of the data.

At 406, the LLM can receive, via the UX, instructions from the user to produce a particular style of data visualization, e.g., such as an x-y chart, scatter plot, bar chart, pie chart, line plot, surface plot, and so forth.

At 408, the LLM can interpret the instructions, e.g., to determine/confirm how the user would like to visualize the data. In some instances, this can involve a question/response interaction with the user via the UX in which the LLM “asks” the user follow-up questions to better understand the instructions.

At 410, the LLM can then reference an extensible visualization library that includes at least a set of predefined functions, e.g., the LLM can compare functions stored in the extensible visualization library, including at least the set of predefined functions, to the instructions to determine whether there is a function that matches the instructions. Note that the set of predefined functions can be designed to handle common data visualization tasks, such as plotting graphs, creating charts, and generating complex visual representations of measurement data. Thus, the library, and more particularly, the set of predefined functions, can be considered an extensive repository of example visualizations that can be used as references by an LLM. These examples can cover a wide range of data visualization scenarios, providing valuable insights into best practices for representing complex measurement data. In addition, the LLM may have stored additional functions in the extensible visualization library. These additional functions can be generated by the LLM from prior user instructions.

At 412, the LLM can determine whether there is an exact match between functions in the extensible visualization library and the instructions. At 414, if and/or when the LLM finds a function within the extensible visualization library that matches the instructions, the LLM can use code associated with the function for initial visualization of the data. At 416, if and/or when the LLM does not find an exact match between functions in the extensible visualization library and the instructions, the LLM can determine whether a function is a close match to the instructions. A close match can be considered a function that meets a high percentage of visualization requirements associated with the instructions, e.g., such as 50%, 75%, 90%, and so forth, depending on user or organizational preference. At 418, if and/or when the LLM determines a function that is a close match, the LLM can generate code based on the function that is the close match and/or use code associated with the function that is the close match for initial visualization of the data. At 420, if and/or when the LLM does not find a function that is a close match, the LLM can generate code for visualization of the data based. The code, at least in some instances, can be based on one or more functions that the LLM determines are relative matches, e.g., one or more functions that do not meet the requirements of being a close match, but do meet a lesser requirement of being a relative match (e.g., if a close match is 50%, a relative match can be 25%, if a close match is 75%, a relative match can be 50%, and so forth).

At 422, the LLM can present, via the UX, the visualization of the data to the user.

At 424, the LLM can finalize the visualization with user interaction. For example, the LLM, via the UX, can receive instructions from the user to alter one or more attributes of the visualization. Attributes can include fields such as chart title, axis titles, color schemes, axis scales, fonts for various text fields, and so forth.

At 426, the LLM can determine to add code associated with the finalized visualization as a function in the extensible visualization library.

At 428, the LMM can, via instructions received via the UX, export the finalized visualization. For example, the LLM can save the finalized visualization in a user specified format in a user specified location. As another example, the LLM can add the finalized visualization to a user specified document in a user specified location. As a further example, the LLM can generate a new document that includes the finalized visualization.

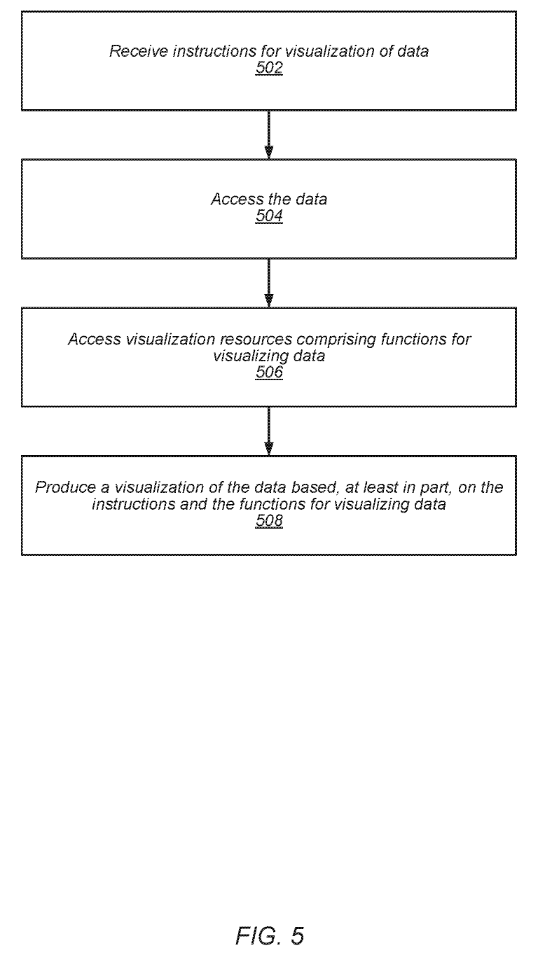

FIG. 5 illustrates a block diagram of an example of a method for artificial intelligence (AI) assisted visualization of data, according to some embodiments. The method shown in FIG. 5 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 502, a large language model (LLM), such as LLM 304 can receive instructions for visualization of data. The instructions can be received via a chat style user experience interface (UX). In some instances, the LLM can located on a server.

At 504, the LLM can access the data.

At 506, the LLM can access visualization resources. The visualization resources can include functions for visualizing data. The visualization resources can include an extensible visualization library.

At 508, the LLM can produce a visualization of the data based, at least in part, on the instructions and the functions for visualizing data. The data visualization can be produced in a chat style UX.

In some instances, when the functions for visualizing data include an extensible visualization library, to produce the visualization of the data based, at least in part, on the instructions and the functions for visualization of the data, the LLM can compare the instructions to functions in the extensible visualization library and determine whether at least one function is an exact match to the instructions.

In some instances, when the LLM determines that at least one function is an exact match to the instructions, the LLM can generate the visualization of the data using code associated with the at least one function. An exact match can be considered a function that meets at least 95 percent of visualization requirements associated with the instructions.

In some instances, when the LLM determines that there is not at least one function that is an exact match to the instructions, the LLM can determine whether there is at least one function that is a close match to the instructions. A close match can be a function that matches a first percentage of requirements associated with the instructions. A close match can be considered a function that meets or exceeds the first percentage of requirements associated with the instructions, e.g., the first percentage can be 50%, 75%, 90%, and so forth. In some instances, the first percentage can depend on and/or be specified by user or organizational preference.

In some instances, when the LLM determines that there is at least one function that is a close match to the instructions, the LLM can generate code based on code associated with the at least one function that is a close match to the instructions and generate the visualization of the data using the generated code. The LLM can add the generated code to the extensible visualization library as a new function.

In some instances, when the LLM determines that there is not at least one function that is a close match to the instructions, the LLM can determine whether there are one or more functions that are a relative match to the instructions. A relative match is a function that matches a second percentage of requirements associated with the instructions. The second percentage can be less than the first percentage. A relative match can be considered a function that does not meet the first percentage but does meet the second percentage, e.g., if the first percentage is 50%, a second percentage can be 25%, if the first percentage is 75%, the second percentage can be 50%, and so forth). In some instances, the second percentage can depend on and/or be specified by user or organizational preference.

In some instances, when the LLM determines that there are one or more functions that are a relative match to the instructions, the LLM can generate code based on code associated with the one or more functions that are a relative match to the instructions and generate the visualization of the data using the generated code. The LLM can add the generated code to the extensible visualization library as a new function.

In some instances, when the LLM determines that there are not one or more functions that are a relative match to the instructions, the LLM can generate code based on the instructions and generate the visualization of the data using the generated code. The LMM can add the generated code to the extensible visualization library as a new function.

In some instances, the LLM can receive further instructions to customize the visualization of the data. The LLM can update the visualization of the data based on the further instructions and finalize the visualization of the data. The LLM can add the code generated based on the visualization of the data to an extensible visualization library as a new function.

In some instances, the LLM can export the visualization of the data. The export of the visualization of the data can include at least one of the LLM saving the visualization of data in a user specified format in a user specified location, the LLM adding the visualization of data to a user specified document in a user specified location, and/or the LLM generating a new document that includes the visualization of data.

Embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a computer system 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for artificial intelligence (AI) assisted visualization of data, comprising:
receiving, by a large language model (LLM), instructions for visualization of data;
accessing, by the LLM, the data;
accessing, by the LLM, visualization resources comprising functions for visualizing data; and
producing, by the LLM, a visualization of the data based, at least in part, on the instructions and the functions for visualizing data.

2. The method of claim 1,
wherein the resources comprising functions for visualizing data comprise an extensible visualization library, and wherein producing the visualization of the data based, at least in part, on the instructions and the functions for visualization of the data comprises:
comparing, by the LLM, the instructions to functions in the extensible visualization library; and
determining, by the LLM, whether at least one function is an exact match to the instructions.

3. The method of claim 2, further comprising:
determining, by the LLM, that at least one function is an exact match to the instructions; and
generating, by the LLM, the visualization of the data using code associated with the at least one function.

4. The method of claim 2, further comprising:
determining, by the LLM, that there is not at least one function that is an exact match to the instructions; and
determining, by the LLM, whether there is at least one function that is a close match to the instructions, wherein a close match is a function that matches a first percentage of requirements associated with the instructions.

5. The method of claim 4, further comprising:
determining, by the LLM, that there is at least one function that is a close match to the instructions;
generating, by the LLM, code based on code associated with the at least one function that is a close match to the instructions; and
generating, by the LLM, the visualization of the data using the generated code.

6. The method of claim 5, further comprising:
adding, by the LLM, the generated code to the extensible visualization library as a new function.

7. The method of claim 4, further comprising:
determining, by the LLM, that there is not at least one function that is a close match to the instructions;
determining, by the LLM, whether there are one or more functions that are a relative match to the instructions, wherein a relative match is a function that matches a second percentage of requirements associated with the instructions, wherein the second percentage is less than the first percentage.

8. The method of claim 7, further comprising:
determining, by the LLM, that there are one or more functions that are a relative match to the instructions;
generating, by the LLM, code based on code associated with the one or more functions that are a relative match to the instructions; and
generating, by the LLM, the visualization of the data using the generated code.

9. The method of claim 8,
adding, by the LLM, the generated code to the extensible visualization library as a new function.

10. The method of claim 7, further comprising:
determining, by the LLM, that there are not one or more functions that are a relative match to the instructions;
generating, by the LLM, code based on the instructions; and
generating, by the LLM, the visualization of the data using the generated code.

11. The method of claim 10, further comprising:
adding, by the LLM, the generated code to the extensible visualization library as a new function.

12. A non-transitory computer-readable memory medium storing program instructions which, when executed by a processor, are configured to cause a computing device to perform operations comprising:
receiving, by a large language model (LLM), instructions for visualization of data;
accessing, by the LLM, the data;
accessing, by the LLM, visualization resources comprising functions for visualizing data; and
producing, by the LLM, a visualization of the data based, at least in part, on the instructions and the functions for visualizing data.

13. The non-transitory computer readable memory medium of claim 12,
wherein the program instructions, when executed by the processor, are further configured to cause the computing device to perform operations comprising:
receiving, by the LLM, further instructions to customize the visualization of the data;
updating, by the LLM, the visualization of the data based on the further instructions; and
finalizing, by the LLM, the visualization of the data.

14. The non-transitory computer readable memory medium of claim 13,
wherein the program instructions, when executed by the processor, are further configured to cause the computing device to perform operations comprising:
adding, by the LLM, code generated based on the visualization of the data to an extensible visualization library as a new function.

15. The non-transitory computer readable memory medium of claim 12,
wherein the program instructions, when executed by the processor, are further configured to cause the computing device to perform operations comprising:
exporting, by the LLM, the visualization of the data.

16. The non-transitory computer readable memory medium of claim 15,
wherein exporting, by the LLM, the visualization of the data includes at least one of:
saving, by the LLM, the visualization of data in a user specified format in a user specified location;
adding, by the LLM, the visualization of data to a user specified document in a user specified location; or
generating, by the LLM, a new document that includes the visualization of data.

17. An apparatus, comprising:
a memory; and
at least one processor in communication with the memory and configured to perform operations comprising:
receiving, by a large language model (LLM), instructions for visualization of data;
accessing, by the LLM, the data;
accessing, by the LLM, visualization resources comprising functions for visualizing data; and
producing, by the LLM, a visualization of the data based, at least in part, on the instructions and the functions for visualizing data.

18. The apparatus of claim 17,
wherein the instructions are received via a chat style user experience interface.

19. The apparatus of claim 17,
wherein the data visualization is produced in a chat style user experience interface.

20. The apparatus of claim 17,
wherein the LLM is located on a server.
